(19) United States
(12) Patent Application Publication
(10) Pub. No.: US 2014/0180831 A1
(43) Pub. Date: Jun. 26, 2014

(54) SYSTEM FOR DETERMINING FEES FOR ONLINE AD IMPACT

(71) Applicant: YAHOO! INC., Sunnyvale, CA (US)

(72) Inventors: Eric Bax, Altadena, CA (US); Valeria Montero, Philadelphia, PA (US)

(73) Assignee: Yahoo! Inc., Sunnyvale, CA (US)

(21) Appl. No.: 13/727,210

(22) Filed: Dec. 26, 2012

(51) Int. Cl. G06Q 30/02

(52) U.S. Cl. CPC G06Q 30/0275
USPC 705/14.71; 705/14.73

(57) ABSTRACT

An electronic device implemented method includes facilitating an auction for an ad space of an advertisement network. A bid and a creative are received from an advertiser for the ad space. An attribute of the creative is determined that is obtrusive to a viewer experience. An extent that the attribute is obtrusive is determined. An extent that the attribute is effective in obtaining a goal of the advertiser is determined. A correlation between the extent that the attribute is obtrusive and the extent that the attribute is effective in obtaining a goal of the advertiser is determined.

### FIELD

Example embodiments may relate to Internet advertisement auctions, such as second price auctions (also known as Vickrey auctions).

### BACKGROUND

Ad exchanges, such as Yahoo's RightMedia Exchange, are technology platforms that facilitate auctions of online advertising inventory from multiple online publishers. For example, an ad exchange can facilitate auctioning off ad space on websites of online publishers. Through these websites, advertisers can then successfully reach an audience by having their ads displayed on webpages of such websites.

### BRIEF DESCRIPTION OF THE DRAWINGS

The systems and methods may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a block diagram of one example of a network that can implement one example of an auction.

FIG. 2 is a block diagram of one example of an electronic device that can implement an aspect of one example of an auction.

FIG. 3 describes example notations that may be utilized by example aspects of one example auction and includes one example of outcomes under an example second price auction.

FIG. 4 is a flowchart of an example method that can be performed by one or more aspects of one example auction.

FIG. 5 is an example probability density function of ad effectiveness minus ad externalities.

### DETAILED DESCRIPTION

Described herein are a systems and methods for auctioning Internet advertising. One example is a Pigovian Second Price Auction System (PSPAS), but other systems can be used. The systems and methods may facilitate selecting less obtrusive ads for an ad space on the Web. The systems and methods may also facilitate charging more for ads that are more obtrusive, unless such ads' effectiveness is tied to their obtrusiveness, for example. The systems and methods may also provide solutions for limiting or moderating obtrusive ads that are efficient for all parties involved, including advertisers, viewers, web publishers, and auctioning platforms. The systems and methods may be Pareto efficient. Also, alternatively or in addition to these systems and methods, the auction system may provide suggested additional fees to compensate for ad obtrusiveness that makes sense for the web publisher, advertiser, and viewer.

The auction system may include an electronic auction process that selects online advertisements based upon a creative's impact on viewer experience in addition to bids for publication of the creative (the creative's impact being, for example, one or more advertisements' or ad campaigns' impact on viewer experience). In such a selection, the auction process selects ads that will be favorable to the parties involved including the web publisher, advertiser, and viewer, e.g., instead of charging an arbitrary fee.

The auction system may include a computer-implemented method that may include a processing device, that can determine which one or more attributes of a creative may be obtrusive. The method may also include a second aspect that can determine an extent to which the attribute(s) contribute to obtrusiveness. Further, method may include a third aspect that can determine the one or more attributes' effectiveness in obtaining an advertiser's goal. Also, a fourth aspect may determine a correlation between the obtrusiveness of the attribute(s) and their effectiveness in obtaining the advertiser's goal. Also included is a fifth aspect then can determine a charge for the obtrusive attribute(s) that relates to a correlation between the obtrusiveness and the effectiveness of the attribute(s). For example, where correlations are at their highest the fees are at their lowest, and vice versa. Also, for example, where obtrusiveness and effectiveness are completely dependent on each other for a creative (highest correlation), there may be a minimum charge. Further, for example, a highest set charge (such as a determine maximum charge) may be for when the two factors are completely independent of each other (zero correlation).

In addition to the first through fifth aspects, a sixth aspect may provide a fee for the creative that may include the aforementioned charge for obtrusiveness and a bid received in a respective auction. For example, the bid may be a second highest bid of a second price auction that is granted to the highest bidder.

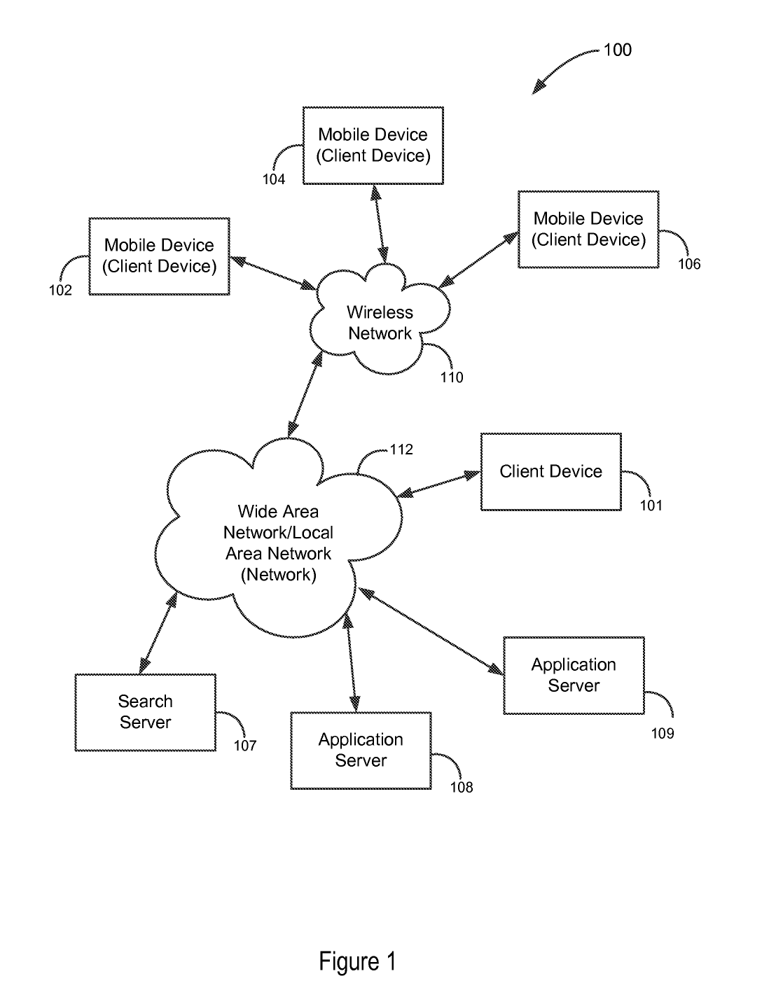

FIG. 1 is a block diagram of an exemplary network that can implement the auction system. In FIG. 1, for example, a network 100 may include a variety of networks, e.g., local area network (LAN)/wide area network (WAN) 112 and wireless network 110, a variety of devices, e.g., client device 101 and mobile devices 102-106, and a variety of servers, e.g., application servers 108 and 109 (e.g., advertisement, web, email, and/or messaging servers) and search server 107.

A network, e.g., the network 100, may couple devices so that communications may be exchanged, such as between servers, servers and client devices or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Sub-networks may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network, e.g., as wireless network 110, may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly.

Signal packets communicated via a network, e.g., a network of participating digital communication networks, may be compatible with or compliant with one or more protocols. Signaling formats or protocols employed may include, for example, Transmission Control Protocol/Internet Protocol (TCP/IP), User Datagram Protocol (UDP), or the like. Versions of the Internet Protocol (IP) may include IP version 4 (IPv4) or version 6 (IPv6).

The Internet refers to, for example, a decentralized global network of networks. The Internet may include local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

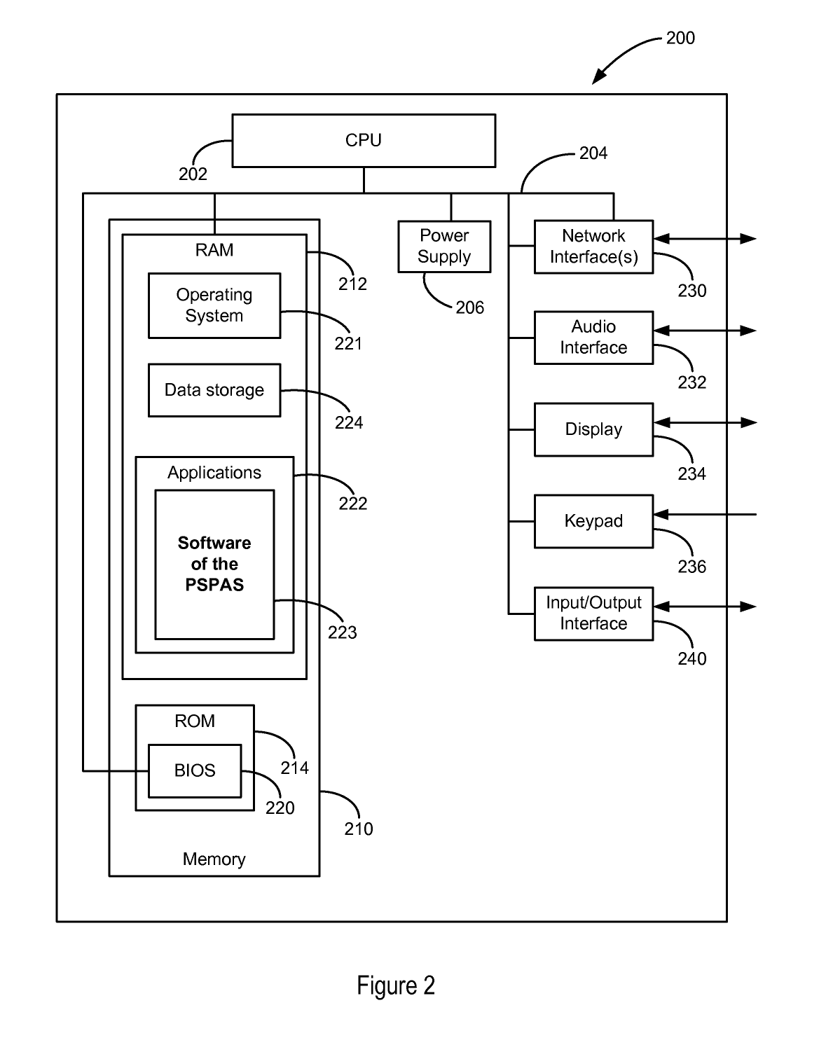

FIG. 2 illustrates a block diagram of an electronic device 200 that can implement an aspect of the auction system. Instances of the electronic device 200 may include servers, such as servers 107-109, and client devices, such as client devices 101-106. A client device may be a desktop computer, a laptop computer, a tablet, or a smartphone, for example. In general, the electronic device 200 can include a processor 202, memory 210, a power supply 206, and input/output components, such as network interface(s) 230, an audio interface 232, a display 234, a key pad or keyboard 236, an input/output interface 240, and a communication bus 204 that connects the aforementioned elements of the electronic device. The network interfaces 230 can include a receiver and a transmitter (or a transceiver), and an antenna for wireless communications. The processor 202 can be one or more of any type of processing device, such as a central processing unit (CPU). Also, for example, the processor 202 can be central processing logic; central processing logic may include hardware, firmware, software and/or combinations of each to perform a function(s) or an action(s), and/or to cause a function or action from another component. Also, based on a desired application or need, central processing logic may include a software controlled microprocessor, discrete logic such as an application specific integrated circuit (ASIC), a programmable/programmed logic device, memory device containing instructions, or the like, or combinational logic embodied in hardware. Also, logic may also be fully embodied as software. The memory 210, which can include RAM 212 or ROM 214, can be enabled by one or more of any type of memory device, such as a primary (directly accessible by the CPU) and/or a secondary (indirectly accessible by the CPU) storage device (e.g., flash memory, magnetic disk, optical disk). The RAM can include an operating system 221, data storage 224, and applications 222, including of software of the auction system 223. The ROM can include BIOS 220 of the electronic device 200. The power supply 206 contains one or more power components, and facilitates supply and management of power to the electronic device 200. The input/output components can include any interfaces for facilitating communication between any components of the electronic device 200, components of external devices (such as components of other devices of the network 100), and end users. For example, such components can include a network card that is an integration of a receiver, a transmitter, and one or more I/O interfaces. A network card, for example, can facilitate wired or wireless communication with other devices of a network. In cases of wireless communication, an antenna can facilitate such communication. Also, the I/O interfaces, can include user interfaces such as monitors, keyboards, touchscreens, microphones, and speakers. Further, some of the I/O interfaces and the bus 204 can facilitate communication between components of the electronic device 200, and can ease processing performed by the processor 202.

Where the electronic device 200 is a server, it can include a computing device that is capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Further, a server may vary widely in configuration or capabilities, but generally, a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like. Particularly, the server may be an application server that may include a configuration to provide an application, such as the auction system, via a network to another device. Also, an application server may, for example, host a website that can provide a user interface for the auction system.

Examples of content provided by the abovementioned applications, including the auction system, may include text, images, audio, video, or the like, which may be processed in the form of physical signals, such as electrical signals, for example, or may be stored in memory, as physical states, for example.

The auction system may include a server operable to serve a second price auction. Upon selecting a bid for an advertisement space, payments for the space may be contingent on conversions, such as views, clickthroughs, and actual sales resulting from an impression of an advertisement in the advertisement space. In short, a second price auction may be a sealed-bid auction, where bidders submit bids without knowing the bid of the other bidders in the auction, and in which the highest bidder wins, but the price paid is the second-highest bid.

The auction system may include a server operable to serve a Pigovian second price (PSP) auction. A PSP auction may incorporate a Pigovian charge into a second price auction. For example, the auction system may select ads based on a combination of bids and ad impact on viewer experience. Besides charges based on conversions, such a system may also charge advertisers based on their advertisements' impact on viewer experience (such as based on the obtrusiveness of an ad or on an ad's enhancement to viewer experience).

An advertiser (iε{1, . . . , n}) participates in an auction by submitting a bid (bᵢ) and one or more creatives (such as one or more advertisements or advertisement campaigns) referenced by γᵢ. The bid is driven by the advertiser's private value of an opportunity to advertise (σ₁). Private values of advertisers (σ₁, . . . , σₙ) represent profits that advertisers expect to gain from winning an auction from respective bids (b₁, . . . , bₙ).

The ad creative(s) may be characterized by γ₁, . . . , γₙ, the negative impact that ad creative(s) have on viewer experience (also referred to as negative externalities). These negative externalities may be a web publisher's or auctioning platform's expected net present value of future losses due to impact of ads on viewer experience. Such losses can arise from a lower level of viewer engagement in the future, such as viewers reducing their website or platform use or failing to recommend the website or platform to other viewers. This model assumes mitigation of impact of obtrusive ads; however, alternatively, a similar model may enhance impact of ads that heighten viewer experience.

Referring back to the second price auction, an advertiser with a highest bid is allocated an opportunity to advertise, and this advertiser may pay a platform the second highest bid. In such a case, truth-telling may be relied upon, so it may be assumed that advertisers bid their private values (bᵢ=σᵢ).

In the second price auction, w may be an index associated with the advertiser with the highest bid. This index may be of the maximum from s may be the index of the second-highest bidder (the runner-up). The highest bidder may have a surplus of σ_{w}−σₛ; and a respective platform may gain a payment σₛ and incur negative externalities worth γ_{w} (due to the winning ad's impact on viewer experience). Considering this, the net surplus may be σₛ−γ_{w}. In this example, utility of viewers decreases as the externality of the winning ad (γ_{w}) increases.

Referring back to the PSP auction, such an auction maybe a modified version of the second price auction. In the PSP, advertisers internalize the externalities imposed by their ads. The PSP auction may rank advertisers based on their bids minus the externalities imposed by their ads' impact on viewer experience (bᵢ−γᵢ), and the advertiser with the highest (bᵢ−γᵢ) wins the opportunity to advertise. Also, the winner may pay the platform the second highest bᵢ−γᵢ value plus the winner's externality, (b_{\tilde{s}}−γ_{\tilde{s}})+γ_{\tilde{w}}, given that \tilde{w} is the index of the PSP auction winner, the maximum among b₁−γ₁, . . . , bₙ−γₙ, and \tilde{s} is the index of the second-highest value. The platform may receive this price and bear the externality (−γ_{\tilde{w}}) from displaying the winner's ad. In such a case, the platform's net surplus may be b_{\tilde{s}}−γ_{\tilde{s}}.

Truth-telling may also be relied upon for a PSP auction. Consequently, it may be assumed that advertisers bid their private values (bᵢ=σᵢ). In a PSP auction, a surplus of the winning PSP advertiser may be σ_{\tilde{w}}−[(b_{\tilde{s}}−γ_{\tilde{s}})+γ_{\tilde{w}}]=(σ_{\tilde{w}}−γ_{\tilde{w}})−(σ_{\tilde{s}}−γ_{\tilde{s}}). This surplus may be equivalent to the surplus of the second price auction winning advertiser (σ_{w}−σₛ) in a scenario in which an advertiser's net private value may include costs of the advertiser's externalities, (σ_{\tilde{w}}−γ_{\tilde{w}})−(σ_{\tilde{s}}−γ_{\tilde{s}}). Also, in such a case a platform's surplus may be represented by [(b_{\tilde{s}}−γ_{\tilde{s}})+γ_{\tilde{w}}]−γ_{\tilde{w}}=σ_{\tilde{s}}−γ_{\tilde{s}}. As may be assumed with a second price auction, the utility for viewers decreases as the winning ad's externality (γ_{\tilde{w}}) increases.

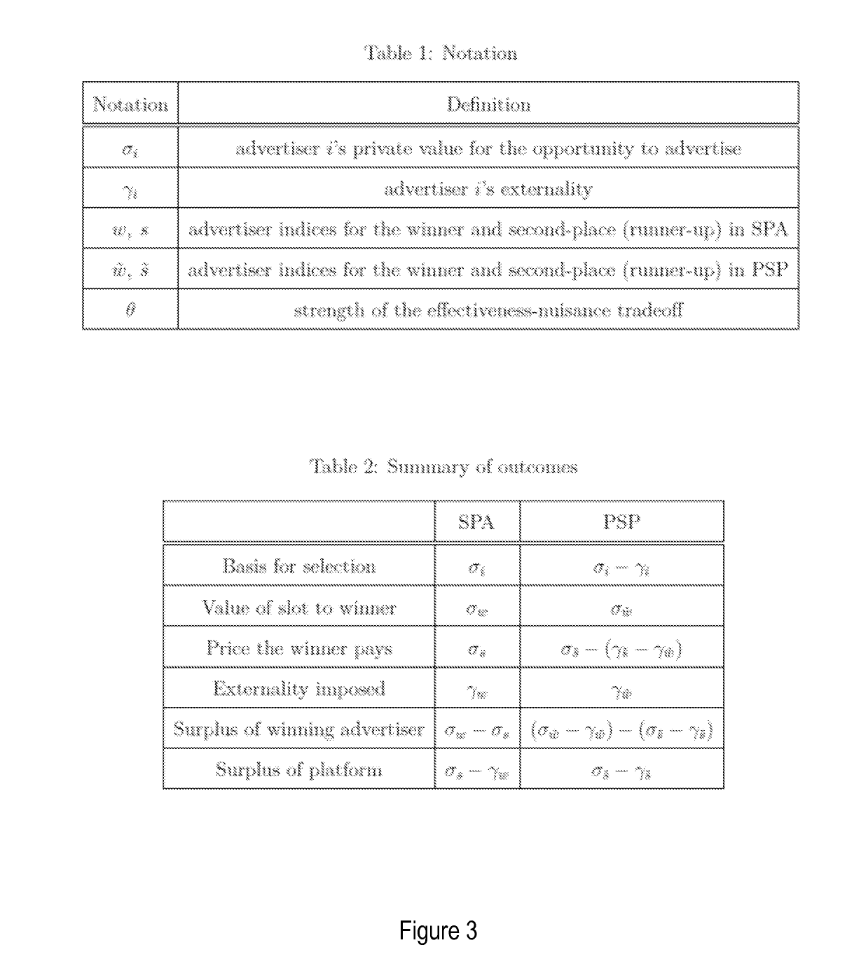

FIG. 3 depicts Tables 1 and 2. Table 1 describes notations of equations described herein. Table 2 summarizes example outcomes under an example second price auction and an example PSP auction, wherein the outcomes under the example second price auction and the example PSP auction may be modeled. For example, an effectiveness-nuisance tradeoff of obtrusive ads can be modeled. This tradeoff reflects the tension between the effectiveness of an ad and its obtrusiveness; and the greater the tradeoff, the greater the difference between the interests of advertisers and viewers/web publishers.

The effectiveness-nuisance tradeoff may be modeled by allowing the private values (σᵢ) and the externalities (γᵢ) to be positively correlated. The private values (σ₁, . . . , σₙ) may be drawn independent and identically distributed from the uniform distribution over [0,1]. An externality γᵢ may combine portions of σᵢ and an independent component, αᵢ. α₁, . . . , αₙ may be drawn independent and identically distributed from the uniform distribution over the range from 0 to 1, U[0,1]. And to vary level of correlation between σᵢ and γᵢ, the model may let γᵢ=c(θσᵢ+(1−θ)αᵢ). Also, the parameter cε(0,1) may control scale of negative externalities. A positive c may ensure that the externalities are negative. Alternatively, the externalities may be positive. The factor θε[0, 1] may control the correlation between σᵢ and γᵢ. A magnitude of θ may capture the extent of the effectiveness-nuisance tradeoff.

When θ=0, σᵢ and γᵢ are independent, so the tradeoff is not present. As θ increases, more obtrusive ads tend to be more highly valued by advertisers.

When θ=1, these elements are positively correlated: γᵢ=cσᵢ. At this extreme, the tradeoff is as strong as possible, and the ad creative that poses the greatest nuisance to viewers (the highest γᵢ) is also the ad creative for which the advertiser is willing to pay the most.

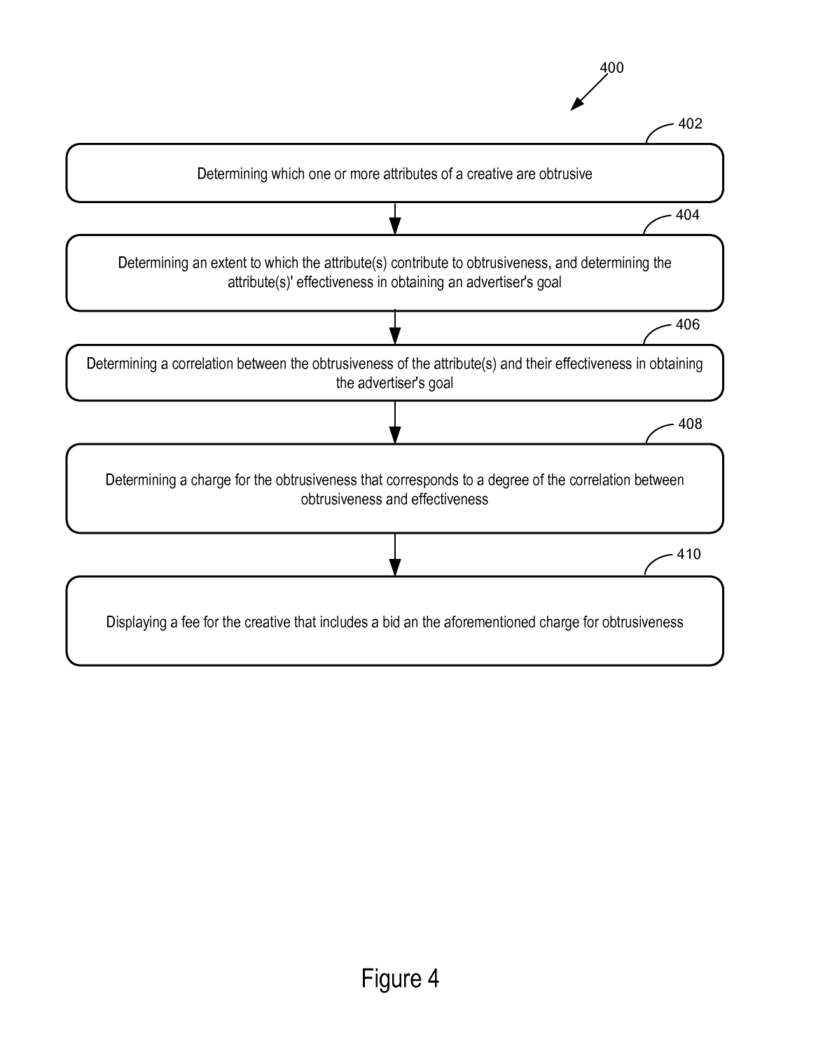

FIG. 4 illustrates a flowchart of an example method that can be performed by one or more aspects of an auction system, such as the electronic device 200 (method 400). In short, the method 400 may include charging more for ads that may be more obtrusive, unless such ads' effectiveness is closely tied to their obtrusiveness. The correlation between ad obtrusiveness and effectiveness may be represented by aspects of the model of the example PSP auction. Also, determining a bid and an additional fee for obtrusiveness of a creative, such as an advertisement or ad campaign, may utilize aspects of the models of the example second price auction and the example PSP auction.

A processor (e.g., the processor 202) can perform the method 400 by executing processing device readable instructions encoded in memory (e.g., the memory 210). The instructions encoded in memory may include a software aspect of the auction system, such as the software 223.

The method 400 may begin with a processing aspect of an electronic device determining which one or more attributes of a creative may be obtrusive (at 402). As described herein a creative may be one or more advertisements or ad campaigns, for example.

Prior to 402, an advertiser iε{1, . . . , n} may participate in an auction by submitting a bid (bᵢ) and a creative (γᵢ). As mentioned, the bid may be driven by the advertiser's private value of an opportunity to advertise (σ₁). In one example, private values of advertisers (σ₁, . . . , σₙ) may represent the profits that advertisers expect to gain from winning the auction from respective bids (b₁, . . . , bₙ). In such a case, creatives may be characterized by γ₁, . . . , γₙ, which may represent negative impact that the creatives have on viewer experience.

An advertiser with a highest bid may be allocated an opportunity to advertise, and this advertiser may pay a platform (such as a platform facilitating the method 400) the second highest bid. In such a case, truth-telling may also be relied upon, so it may be assumed that advertisers bid their private values (bᵢ=σᵢ). In one example, w may be an index associated with the advertiser with the highest bid. This index may be of the maximum from σ₁, . . . , σₙ. And s may be an index of the second-highest bidder. The highest bidder may have a surplus of σ_{w}−σₛ; and a respective platform may gain a payment σₛ and incur negative externalities worth γ_{w}.

At 404, the method continues with the processing aspect or another processing aspect determining an extent to which the attribute(s) contribute to obtrusiveness, and determining the attribute(s)′ effectiveness in obtaining an advertiser's goal. The advertiser's goal may be a clickthrough, a purchase resulting from an advertisement, an impression, improvement in brand recognition, or improvement in brand affinity.

The auction may rank advertisers based on their bids minus the obtrusiveness of their ads (bᵢ−γᵢ). The advertiser with the highest bᵢ−γᵢ (not necessarily the highest bidder) may win the opportunity to advertise. In this case, let \tilde{w} represent an index of such an auction winner. And let \tilde{s} represent an index of the second-highest value. Truth-telling may also be relied upon. As a consequence, it may be assumed that advertisers bid their private values (bᵢ=σᵢ); and a surplus of the winning advertiser may be σ_{\tilde{w}}−[(b_{\tilde{s}}−γ_{\tilde{s}})+γ_{\tilde{w}}]=(σ_{\tilde{w}}−γ_{\tilde{w}})−(σ_{\tilde{s}}−γ_{\tilde{s}}). In such a case a platform's surplus may be [(b_{\tilde{s}}−γ_{\tilde{s}})+γ_{\tilde{w}}]−γ_{\tilde{w}}=σ_{\tilde{s}}−γ_{\tilde{s}}. Also, since bᵢ−γᵢ increases the platform's surplus, besides using bᵢ−γᵢ to determine the ranking of an advertiser, it may also be a factor in determining a fee for publishing a creative to an ad space.

At 406, the method continues with the processing aspect or another processing aspect determining a correlation between the obtrusiveness of the attribute(s) and their effectiveness in obtaining the advertiser's goal. As mentioned, an effectiveness-nuisance tradeoff of obtrusive ads can be modeled. For example, the greater the tradeoff, the greater the difference between the interests of advertisers and viewers/web publishers. Also as mentioned, the effectiveness-nuisance tradeoff may be modeled by allowing the private values (σᵢ) and the externalities (γᵢ) to be positively correlated, for example.

At 408, the method continues with the processing aspect or another processing aspect determining a charge for the obtrusiveness that corresponds to a degree of the correlation between obtrusiveness and effectiveness. For example, where the correlation is at its highest a fee may be at its lowest. Where obtrusiveness and effectiveness are completely dependent on each other for an ad, there would be a minimum charge, for example. And a highest charge (such as a determined maximum charge) may be for when the obtrusiveness and effectiveness of the attribute(s) are completely independent of each other (zero correlation).

At 410, one or more aspects of the auction system may provide a fee for the creative that may include a bid (such as a second highest bid of a second price auction) and the charge for obtrusiveness. Furthermore, the fee may be based on the ranking of the advertiser.

This fee may then be displayed on an output device along with an itemization of the fee. The itemization of the fee may include the portion of the fee associated with the charge for obtrusiveness and the bid.

The advertiser may pay a respective platform the second highest bᵢ−γᵢ value plus the winner's externality, (b_{\tilde{s}}−γ_{\tilde{s}})+γ_{\tilde{w}}. Also, for example, the platform may receive this price and bear the externality −γ_{\tilde{w}} from publishing the creative. In such a case, the platform's net surplus may be b_{\tilde{s}}−γ_{\tilde{s}}.

Given the abovementioned methods and models, it is important to show that such methods and models benefit not only web publishers and viewers, but also the advertisers. In such as case, the auction system is Pareto efficient. Meaning an improvement for one party does not make another party's situation worse off. The following paragraphs provide models that illustrate situations when the auction system is beneficial to the advertiser, viewer, and website publisher or platform. After describing these models, provided is a discussion on some example s.

It is intended that the foregoing and following descriptions be regarded as illustrative rather than limiting, and that it be understood that it is the following claims, including all equivalents, that are intended to define the spirit and scope of this invention.

### Pareto Efficiency Analysis of the Auction System

This section describes potential adoptions of a PSP auction that may simultaneously benefit advertisers, viewers, and a web platform or publisher, under a set of marketplace conditions. As described, both viewers and a web platform or publisher benefit from a PSP auction when 0≦θ<1. Thus, Pareto efficiency may be primarily driven by preferences of advertisers. Given this, a PSP auction may favor a winning advertiser when θ=0, and when θ<1. In short a PSP auction may be favorable where the number of competing advertisers is sufficiently large. This impact of a PSP auction on marketplace players with respect to θ may represent an extent of the effectiveness-nuisance tradeoff. And Expectations of the propositions are given with respect to joint distributions of σ₁, . . . , σₙ (private values of advertisers) and γ₁, . . . , γₙ (impacts that the creatives have on viewer experience).

### The Winning Advertiser

Below describes situations where advertisers may benefit from a charge for ad impact (such as negative ad impact) on viewer experience.

To summarize, in one case, when θ=0, advertisers benefit from a PSP auction. At the other extreme, when θ=1, advertisers may be harmed by a PSP auction. In between, when θε(0,1), both a level of correlation (based on θ) and the number of advertisers (n) jointly determine whether advertisers benefit. As the correlation factor increases (or as the tradeoff strengthens), advertisers benefit from PSP as long as enough advertisers participate.

Below is an independent case, when the effectiveness-nuisance tradeoff is not present.

Proposition 1: For θ=0, the expected surplus of the winning advertiser is larger under a PSP auction than, for example, under second price auction,

E[σ_{w}−σₛ]<E[(σ_{\tilde{w}}−γ_{\tilde{w}})−(σ_{\tilde{s}}−γ_{\tilde{s}})]. (1)

The surplus of the winning advertiser is σ_{w}−σₛ in a second price auction and it is (σ_{\tilde{w}}−γ_{\tilde{w}})−(σ_{\tilde{s}}−γ_{\tilde{s}}) in a PSP auction (See Table 2 of FIG. 3). Evaluations of σᵢ−γᵢ in PSP may relate to σᵢ in second price auction. Where γᵢ is independent of σᵢ, for example, σᵢ−γᵢ has a greater variance than σᵢ. Therefore, in such a case, a difference between the two highest σᵢ−γᵢ values (the surplus to the advertiser under PSP) is greater than the difference between the two highest σᵢ values (the surplus to the advertiser under second price auction). In other words, introducing another factor (such as externalities) to the evaluations causes them to become more dispersed, allowing the winning advertiser to obtain a greater surplus.

Where σᵢ and γᵢ are perfectly positively correlated (θ=1), a PSP auction may be detrimental to advertisers. When θ=1, γᵢ is determinable by a private value σᵢ, so γᵢ=cσᵢ, and σᵢ−γᵢ=σᵢ(1−c). Since σᵢ−γᵢ are scaled versions of σᵢ, rankings of bidders becomes the same under a PSP auction and a second price auction, for example. The advertiser wins under both auctions since \tilde{w}=w. However, the advertiser's surplus under PSP equals (σ_{\tilde{w}}−γ_{\tilde{w}})−(σ_{\tilde{s}}−γ_{\tilde{s}})=(1−c)(σ_{w}−σₛ), which is less than the surplus under second price auction, saw σw−σₛ, in this case.

Where 0<θ<1, as σᵢ and γᵢ become more positively correlated, θ approaches 1 (θ→1) and the variance of σᵢ−γᵢ decreases, eroding any benefit to advertisers. Nevertheless, advertisers can still benefit from PSP if enough advertisers bid.

For example, let g( ) be the probability density function of σᵢ−γᵢ and let G( ) be the cumulative distribution function. The advertiser surplus under a PSP auction can then be represented by:

(σ_{\tilde{w}}−γ_{\tilde{w}})−(σ_{\tilde{s}}−γ_{\tilde{s}})=G⁻¹(G(σ_{\tilde{w}}−γ_{\tilde{w}}))−G⁻¹(G((σ_{\tilde{s}}−γ_{\tilde{s}})), (2)

Where g( ) is continuous, G(σᵢ−γᵢ)˜U[0,1] may result.

The random variable G(σ_{\tilde{w}}−γ_{\tilde{w}}) is an n^{th} order statistic of n uniform random variables G(σ₁−γ₁), . . . , Gσₙ−γₙ). This n^{th} order statistic is distributed by Beta(n, 1), which has a mean

$$\frac{n}{n + 1} .$$

Similarly, G(σ_{\tilde{s}}−γ_{\tilde{s}}) is an n−1^{st} order statistic, with a distribution Beta(n−1,2), and a mean

$$\frac{n - 1}{n + 1} .$$

To approximate the mean of the left hand side (LHS) of Equation (2), used is the right hand side (RHS) of Equation (2) and substituted is the means of G(σ_{\tilde{w}}−γ_{\tilde{w}}) and G(σ_{\tilde{s}}−γ_{\tilde{s}}) for their values:

$$E [ ( {σ}_{\tilde{w}} - {γ}_{\tilde{w}} ) - ( {σ}_{\tilde{s}} - {γ}_{\tilde{s}} ) ] \approx {G}^{- 1} ( \frac{n}{n + 1} ) - {G}^{- 1} ( \frac{n - 1}{n + 1} ) . \qquad ( 3 )$$

Substituting these means inside a non-linear function leads to an approximation of the LHS. This approximation may become more accurate as n increases because the beta distributions become more concentrated around the means. From Equation (3), the advertiser surplus under a PSP auction is approximately equal to the distance between

$${G}^{- 1} ( \frac{n}{n + 1} )$$

$$and$$

$${G}^{- 1} ( \frac{n - 1}{n + 1} ) .$$

Since G( ) is a cumulative distribution function, the area under the probability density function g( ) from

$${G}^{- 1} ( \frac{n - 1}{n + 1} )$$

$$to$$

$${G}^{- 1} ( \frac{n}{n + 1} )$$

$$equals$$

$$\frac{n}{n + 1} .$$

So, if the height of the probability density function g( ) between these two points decreases, then the distance between them (the surplus) increases.

For advertiser surplus under second price auction, let ƒ( ) be the probability density function of σᵢ, and let F( ) be the cumulative distribution function. Following the reasoning for PSP, we can approximate the expected advertiser surplus for second price auction as:

$$E [ {σ}_{w} - {σ}_{s} ] \approx {F}^{- 1} ( \frac{n}{n + 1} ) - {F}^{- 1} ( \frac{n - 1}{n + 1} ) . \qquad ( 4 )$$

With respect to a PSP auction, the expected surplus for second price auction is approximately the distance to the right of

$${F}^{- 1} ( \frac{n - 1}{n + 1} )$$

such that the area under a curve, starting from

$${F}^{- 1} ( \frac{n - 1}{n + 1} ) , \\ is \\ ( \frac{n}{n + 1} ) .$$

Equivalently, dividing support of ƒ into n+1 segments, each covered by

$$\frac{n}{n + 1}$$

of area under ƒ, the advertiser surplus is the distance covered by the second-to-last segment.

A comparison of the advertiser surplus under each auction to estimate when PSP produces more expected surplus can be made, in the following equation: E[σ_{w}−σₛ]<E[(σ_{\tilde{w}}−γ_{\tilde{w}})−σ_{\tilde{s}}−γ_{\tilde{s}})]. Using the approximations from Equations 3 and 4, this is similar to the condition

$${F}^{- 1} ( \frac{n}{n + 1} ) - {F}^{- 1} ( \frac{n - 1}{n + 1} ) < {G}^{- 1} ( \frac{n}{n + 1} ) - {G}^{- 1} ( \frac{n - 1}{n + 1} ) .$$

If the second-to-last segment supporting

$$\frac{1}{n + 1}$$

of area under g( ) covers more distance than the second-to-last segment supporting

$$\frac{1}{n + 1}$$

of area under ƒ( ), then a PSP auction is favorable for advertisers. Equivalently, a lower right tail in g( ) than in ƒ( ) makes a PSP auction favorable.

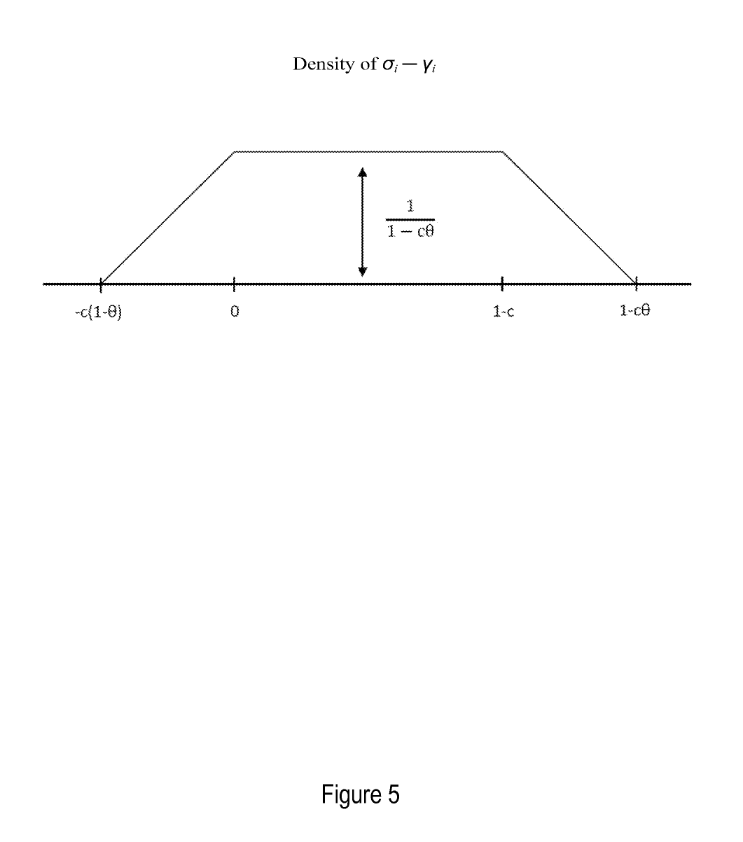

In this model, the area under ƒ is a square, with height one over [0,1] and zero elsewhere. In contrast, the area under g( ) is a trapezoid, in FIG. 5. The maximum height of the trapezoid is

$$\frac{1}{1 - c θ} ,$$

which is greater than 1. As θ−1, sides of the trapezoid become steeper and cover less horizontal distance, making the trapezoid resemble a tall rectangle.

A PSP auction is favorable to advertisers when (σ_{\tilde{s}}−γ_{\tilde{s}}) is far enough along the right side of the trapezoid that g((σ_{\tilde{s}}−γ_{\tilde{s}})≦1. In this case, g(x)≦1 for xε[σₛ−γ_{\tilde{s}}, σ_{\tilde{w}}−γ_{\tilde{w}}], so g(x)≦ƒ(x) over this domain, making a PSP auction favorable to second price auction, for example. Using the approximation from Equation 3, this condition is approximately the same as

$$g ( {G}^{- 1} ( \frac{n - 1}{n + 1} ) ) < 1. \qquad ( 5 )$$

Also, n can be solved for to estimate sufficient competitiveness in a market to make a PSP auction favorable. A variable s*=(1−cθ)−[c(1−θ)(1−cθ) is a point at which g(s*)=1. The Inequality (5) is true when

$${G}^{- 1} ( \frac{n - 1}{n + 1} ) \geq {s}^{*} ,$$

or, equivalently,

$$\frac{n - 1}{n + 1} \geq G ( {s}^{*} ) . \qquad ( 6 )$$

Since s* is c(1−θ)(1−cθ) from the right side of the trapezoid, 1−G(s*) equals the area under g( ) from s* to the lower right corner of the trapezoid. This area is a triangle of height 1 and length c(1−θ)(1−cθ). So, G(s*)=1−½c(1−θ)(1−cθ). Combining this last equality with (6) gives

$$n \geq 4 ( \frac{1}{c ( 1 - θ ) ( 1 - c θ )} ) - 1. \qquad ( 7 )$$

When Inequality (7) is true, the highest two values in a PSP auction σᵢ−γᵢ occur far enough into the right tail of the trapezoid so that the height of the probability density function is less than 1.

In short, for 0<θ<1, a PSP auction improves the surplus of an advertiser relative to second price auction as long as the number of advertisers (n) is larger than an approximate lower bound

$$4 ( \frac{1}{c ( 1 - θ ) ( 1 - c θ )} ) - 1 ,$$

which increases as θ→1.

### The Viewer

Regarding viewers, this party of an advertisement exchange benefits when a platform switches to a PSP auction, because the auction is designed to improve viewer experience relative to second price auction by making advertisers internalize the externalities (such as intrusiveness) imposed by their ads. Assuming quality of viewer experience decreases as the negative externality of a winning ad increases, a PSP auction may never harm viewer experience. In short, given is a second proposition, proposition 2, which assumes externalities are always negative and that switching from second price auction to a PSP auction should never harm the viewer experience (in that it never increases the externalities): γ_{\tilde{w}}≦γ_{w}.

Proposition 3: Where the externalities are not perfectly correlated with advertiser valuations (θ<1) and c>0, switching from second price auction to a PSP auction decreases the externalities in expectation, E[γ_{\tilde{w}}]<E[γ_{w}].

### The Auction Platform or Web Publisher

Regarding an auctioning platform or web publisher, using a PSP auction increases these parties' surplus for 0≦θ≦1. As with advertisers, these parties benefit from a PSP auction when the tradeoff is not present. When the externalities and private values are independent (θ=0), for example.

Proposition 4: Where σᵢ and γᵢ are independent (θ=0), a PSP auction increases an expected surplus of the platform or web publisher, E[σₛ−γ_{w}]<E[σ_{\tilde{s}}−γ_{\tilde{s}}].

Where σᵢ and γᵢ are independent, the platform or web publisher benefits because the runner up in a PSP auction is likely to have both a high private value σᵢ and a low externality γᵢ. As the number of bidding advertisers increases to infinity, the runner up may have one of the highest private values for the slot and one of the lowest externalities. As n→∞, σ_{\tilde{s}}→1 and γ_{\tilde{s}}→0, so σ_{\tilde{s}}−γ_{\tilde{s}}→1. A PSP auction may be able to reduce externalities while maintaining a high ad price, with increased bidders.

Unlike advertisers, the platform or web publisher also benefits from a PSP auction when the tradeoff is strong. When the most obtrusive ads may be also the most effective, for example.

Proposition 5: Where σᵢ and γᵢ are perfectly positively correlated (θ=1), PSP increases the expected surplus of the platform or web publisher, E[σₛ−γ_{w}]<E[σ_{\tilde{s}}−γ_{\tilde{s}}].

Where θ=1 and γᵢ=cσᵢ, a ranking of the advertisers are the same under both types of auction. The winning advertiser under both auctions has both the highest value and the highest externalities. The platform's or web publisher's profits are greater under a PSP auction because it charges the same winner a premium for its externality. Since the platform benefits from a PSP auction at both θ=0 and θ=1, it is not surprising that it also benefits when the strength of the effectiveness-nuisance tradeoff falls between extremes, 0<θ<1.

Proposition 6: Where 0<0<1, a PSP auction increases the expected surplus of the platform or web publisher:

E[σₛ−γ_{w}]<E[σ_{\tilde{s}}−γ_{\tilde{s}}].

In short, a PSP auction benefits each marketplace player. A PSP auction can be adopted under conditions that benefit all players, and can be sustainable in a competitive environment. And, over time, this auction provides advertisers incentives to invest in ads that may be effective without imposing a nuisance on viewers, which may be potential customers.

Although the focus of this disclosure has been on dealing with negative externalities, such as obtrusive attributes of ads or ad campaigns, such systems may also take advantage of possibly rewarding ads or campaigns that may be an attraction instead of a nuisance. In the described models, γᵢ≧0, meaning that a PSP auction imposes penalties for negative ad impact on viewer experience. To add bonuses for positive ad impact on user experience, such models can be modified to allow for negative as well as positive values of γᵢ. One way to model this is to subtract a constant d>0 from γᵢ, so that γᵢ=d, and use γ′ᵢ in place of γᵢ. In other words, the PSP auction selects a winner and runner-up based on σᵢ−γ′ᵢ values. Since we add a constant to ally values, the winner and runner up are the same advertisers as before. The difference is that a winning advertiser gains d, and the platform or web publisher foregoes d.

This modification changes the analysis of Pareto efficiency. Advertisers benefit more from a PSP auction in a setting with positive externalities, so they still should prefer a PSP auction to second price auction for θ=0 and for θ>0. And, the amount of competition required for advertisers to prefer a PSP auction may decrease. In contrast, the platform may lose surplus, so a PSP auction may no longer be beneficial for it over the entire range of θ. In such instances, a PSP auction can now be detrimental to the platform when the highest bids may be good signals of positive externalities, since this allows second price auction to select relatively attractive ads. Where d is small enough, a PSP auction can benefit the platform or web publisher. But if d is too large, the platform or web publisher is no longer guaranteed to benefit from a PSP auction. A platform or website with more advertisers and a lower d is more likely to be able to take advantage of a PSP auction under Pareto efficient conditions.

### Other Example Alternatives

A PSP auction may be designed to improve viewer experience, but due to competitive pressures, an auctioning platform or web publisher may only want to adopt this pricing mechanism if it also benefits advertisers. This type of auction can benefit advertisers, viewers, and the platform or web publisher (be Pareto efficient) if it is adopted under a set of marketplace conditions. This type auction can benefit all players when the effectiveness-nuisance tradeoff is mild. As the tradeoff strengthens (the positive dependence between these elements becomes stronger), more advertisers should be added to maintain the Pareto efficiency of a PSP auction.

Whether an ad exchange is small or grows, maintaining an appropriate effectiveness-nuisance tradeoff is critical. In maintaining this tradeoff at least the following aspects and scenarios may be considered. In short, determinations of the effectiveness-nuisance tradeoff may be based on the following.

Platforms that are mobile applications may manage the effectiveness-nuisance tradeoff of ads in a market in which viewers have more leverage. The interests of viewers may be especially important because peer network effects may drive application adoption. Also, viewers often generate content on a platform and pay to access premium content or to remove ads. In addition to modeling network effects, user generated content, and subscription fees, another direction for future work is to model an effect of application competition, such as a setting where both advertisers and viewers use more than one platform.

Mobile application platforms may also manage the effectiveness-nuisance tradeoff within constraints that may be set by mobile hardware platforms. Such hardware platforms may even subsidize and ban some applications (and their advertisements), based on their impact on mobile viewer experience.

Another factor, is the basis of determining γi values. Although it may not feasible to compute the impact that any single ad will have on a platform's future revenue, it is practical to create a proxy for it. For example, the platform may model both the impact of experiencing an ad with specific features on future viewer engagement and the financial value of future engagement for the platform. Features can include the editorial assessment and properties of ad creatives, such as the length of an animation and the variety of colors displayed. Examples of metrics for viewer engagement may include measures of viewer reactions, such as the rate of complaints or the rate of click backs. A click back occurs when a viewer clicks on an ad and then quickly clicks back from the ad's landing page to the page displaying the ad.

Also, another method to model future engagement in terms of ad features is to regress metrics for viewer engagement onto ad features while taking into account individual-level heterogeneity. Another method is statistical experimentation, which assigns users at random to treatments that include different combinations of levels of multiple ad features, and then uses analysis of variance (ANOVA) or similar methods to estimate influence of different ad feature levels on different engagement metrics. A measure for the externality of an ad creative (such as an ad impact score) can then be developed as the weighted sum of externality measures of its features.

While various embodiments of the systems and methods have been described, it will be apparent to those of ordinary skill in the art that many more embodiments and implementations are possible within the scope of the systems and methods. Accordingly, the systems and methods are not to be restricted except in light of the attached claims and their equivalents.

Subject matter may be embodied in a variety of different forms and, therefore, covered or claimed subject matter is intended to be construed as not being limited to any example set forth herein; examples are provided merely to be illustrative. Among other things, for example, subject matter may be embodied as methods, devices, components, or systems. Accordingly, subject matter may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. The terminology used in the specification is not intended to be limiting of example of the invention. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Likewise, it will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

It will be further understood that the terms “comprises,” “comprising,” “ ” and/or “including,” when used herein, specify the presence of stated features, integers, steps, operations, elements, and/or components, but do not preclude the presence or addition of one or more other features, integers, steps, operations, elements, components, and/or groups thereof, and in the following description, the same reference numerals denote the same elements.

We claim:

1. An electronic device implemented method comprising:
facilitating an auction for an ad space of an advertisement network;
receiving a bid and a creative from an advertiser for the ad space;
determining an attribute of the creative that is obtrusive;
determining an extent that the attribute is obtrusive;
determining an extent that the attribute is effective in obtaining a goal of the advertiser; and
determining a correlation between the extent that the attribute is obtrusive and the extent that the attribute is effective in obtaining a goal of the advertiser.

2. The method of claim 1, wherein the auction includes a sealed-bid auction, where bidders submit bids without knowing a bid of other bidders in the auction, and in which a highest bidder wins, but a price paid is a second-highest bid.

3. The method of claim 1, further comprising determining a fee based on the correlation and the bid.

4. The method of claim 3, wherein the fee is Pareto efficient.

5. The method of claim 3, further comprising ranking the advertiser based on the bid minus the extent that the attribute is obtrusive, wherein the determining of the fee is also based on the ranking of the advertiser.

6. The method of claim 3, wherein there is a minimum charge when the correlation is at its maximum, wherein there is a determined maximum charge when the correlation is at its minimum, and wherein the determining of the fee includes increasing a charge for obtrusiveness with respect to a decrease in the correlation.

7. The method claim 1, wherein the correlation comprises an extent that an attribute is obtrusive which is equivalent to an extent of an attribute is effective obtaining a goal with respect to an extent of an effectiveness-nuisance tradeoff of the attribute.

8. The method of claim 7, wherein an increase in the extent of the effectiveness nuisance tradeoff of the attribute corresponds to a greater dependency between the extent that the attribute is obtrusive and the extent that the attribute is effective in obtaining a goal of the advertiser.

9. An electronic device implemented method comprising:
facilitating an auction for an ad space of an advertisement network;
receiving a highest bid and a creative from an advertiser for the ad space;
determining an attribute of the creative that is obtrusive to a viewer;
determining an extent that the attribute is obtrusive;
determining an extent that the attribute is effective in obtaining a goal of the advertiser;
determining a correlation between the extent that the attribute is obtrusive and the extent that the attribute is effective in obtaining a goal of the advertiser; and
determining a fee based on the correlation and a second highest bid, wherein the highest bid and the second highest bid include private bids.

10. The method of claim 9, further comprising ranking the advertiser based on the bid minus the extent that the attribute is obtrusive, wherein the determining of the fee is also based on the ranking of the advertiser.

11. The method of claim 9, wherein there is a minimum charge when the correlation is at its maximum, wherein there is a determined maximum charge when the correlation is at its minimum, and wherein the determining the fee includes increasing a charge for obtrusiveness with respect to a decrease in the correlation.

12. The method of claim 9, wherein the correlation comprises an extent that an attribute is obtrusive which is equivalent to an extent of an attribute is effective obtaining a goal with respect to an extent of an effectiveness-nuisance tradeoff of the attribute.

13. The method of claim 12, wherein an increase in the extent of the effectiveness nuisance tradeoff of the attribute corresponds to a greater dependency between the extent that the attribute is obtrusive and the extent that the attribute is effective in obtaining a goal of the advertiser.

14. A system comprising:
an interface operable to receive a creative from an advertiser;
a computing device connected with the interface, the computing device operable to:
determine an attribute of the creative that is obtrusive to a viewer;
determine an extent that the attribute is obtrusive;
determine an extent that the attribute is effective in obtaining a goal of the advertiser; and
determine a correlation between the extent that the attribute is obtrusive and the extent that the attribute is effective in obtaining a goal of the advertiser.

15. The system of claim 14, further comprising an output device operable to report an itemization of a fee, and wherein the itemization of the fee includes a charge for obtrusiveness of the creative and a value of a bid associated with the creative.

16. The system of claim 15, wherein the computing device is further operable to rank the advertiser based on the bid minus the extent that the attribute is obtrusive, and to further determine the fee based on the ranking of the advertiser.

17. The system of claim 15, wherein there is a minimum charge when the correlation is at its maximum, wherein there is a determined maximum charge when the correlation is at its minimum, and wherein the determination of the fee includes increasing a charge for obtrusiveness with respect to a decrease in the correlation.

18. The system of claim 14, wherein the correlation comprises an extent that an attribute is obtrusive which is equivalent to an extent of an attribute is effective obtaining a goal with respect to an extent of an effectiveness-nuisance tradeoff of the attribute.

19. The system of claim 14, wherein an increase in the extent of the effectiveness nuisance tradeoff of the attribute corresponds to a greater dependency between the extent that the attribute is obtrusive and the extent that the attribute is effective in obtaining a goal of the advertiser.

20. The system of claim 15, wherein the fee is Pareto efficient.
